(19) United States
(12) Patent Application Publication
(10) Pub. No.: US 2012/0197684 A1
(43) Pub. Date: Aug. 2, 2012

(54) System and Method for Conducting a Design Process Using Market Research

(76) Inventor: Todd M. Storey, Calgary (CA)

(21) Appl. No.: 13/443,595

(22) Filed: Apr. 10, 2012

Related U.S. Application Data
(63) Continuation of application No. 11/756,234, filed on May 31, 2007, now abandoned.
(60) Provisional application No. 60/803,784, filed on Jun. 2, 2006.

(51) Int. Cl. G06Q 30/02; G06Q 40/06

(52) U.S. Cl. 705/7.32; 705/36 R

(57) ABSTRACT

A method and system for conducting a design process using market research includes extending an offer to grant an ownership interest such as an equity interest or security in a company in exchange for receiving feedback from respondent members of a target market. The company may use the feedback in developing and launching a new product. The feedback may relate to desired design specifications, pricing, marketing approaches, and suggested new ideas for the new product. The various options are presented to the respondents as text, audio, video, and in combinations thereof.

### CROSS-REFERENCE TO RELATED APPLICATIONS

The present application is a continuation of U.S. patent application Ser. No. 11/756,234 filed May 31, 2007 which claims priority from U.S. Provisional Application No. 60/803,784 filed Jun. 2, 2006, both of which are incorporated herein by reference.

### FIELD OF THE INVENTION

The present invention relates to the field of methods of conducting a design to process, and, more particularly, to a method and system for designing, improving it and/or launching a new or existing product, and/or for obtaining feedback.

### BACKGROUND OF THE INVENTION

Developing and launching a new consumer product, and improving an existing product, may be a time consuming and expensive process. This complex process may typically involve market research, the evaluation of test market results, and obtaining feedback from the public or from a particular target market.

Often any feedback provided by the public is given with reluctance or apathy, which may generally tend to diminish its value to any entity that may require same, whether such feedback is required to launch a new product, improve an existing one, or otherwise. Respondent apathy or reluctance can stem from any number of underlying causes, but may be generally thought to involve indifference, a lack of emotion, motivation, enthusiasm, or a lack of affiliation or connection to the company, product, service, or data collecting entity. Current market research techniques do little, if anything, to create or instill any connection or true sense of enthusiasm or concern amongst potential respondents for the importance of their role in the data collection process, with the result being that prior art market research efforts may generally have been using data of less than desired relevance or accuracy.

Additionally, the time required to perform market research according to conventional techniques may have been considerable. As a result of the considerable time which might heretofore have been spent in performing any requisite market research, any previously obtained data may have been of reduced relevance by the time of its intended application, e.g. by the time the product was actually made available to the public.

Further, the monetary expense associated with market research according to conventional techniques may have been considerable. The considerable monetary expense associated with performing market research may similarly have resulted in a to generally reduced availability and/or affordability of market research methodologies.

In today's market driven economy and global landscape, customer feedback, market feedback, and feedback from the public at large may be sought in any number of contexts, including, for example, in each of the following: test marketing, small-scale product launches, concept testing, store auditing, product demand testing, sales forecasting, test audiences (e.g. for music, film, television), customer and/or transaction satisfaction studies, exit interviews, distribution and/or retail channel audits, price elasticity testing, consumer decision process research, relative positioning and/or comparative brand research, brand name testing, and advertising and promotion research. All of these forms of market research are subject to the problems outlined above, which may generally be thought to diminish the value of the market research.

What is needed, therefore, is a method and system for market research which obviates or mitigates at least one of the disadvantages of the prior art.

### BRIEF DESCRIPTION OF THE DRAWINGS

The novel features which are believed to be characteristic of the method and system for market research according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a diagrammatic table showing steps sequentially performed by a computer according to one preferred embodiment of a method and system for market research according to the invention; and

FIG. 2 is a diagrammatic flowchart of steps implemented according to the embodiment of the invention shown in FIG. 1.

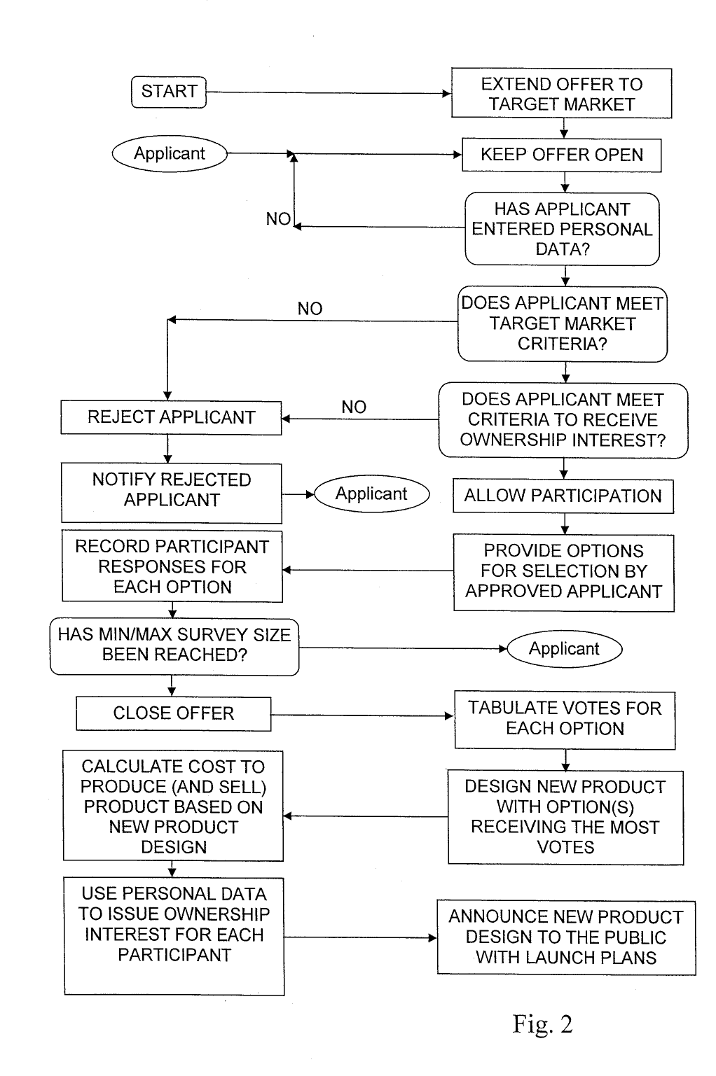

### DETAILED DESCRIPTION OF A PREFERRED EMBODIMENT

In accordance with the present invention there is disclosed a method and/or system for market research that extends an offer of equity ownership, profit sharing and/or security or other financial instrument relating to, conveying or representing an ownership interest, or a contingent or prospective ownership interest, in a data collecting entity and/or in a product vending entity or another entity, in exchange for responses or other participation from potential respondents. An “ownership interest” includes any financial instrument that grants an interest in the equity of the entity or the right, upon the occurrence of an event or contingency, to acquire an interest in the equity of the entity, or that provides an underlying interest or security in the product vending entity or data collection entity.

The invention provides a method of conducting market research in relation to a product or service, comprising the steps of: a. offering an ownership interest in an entity related to the product or service or the market research, to a target group in exchange for information, b. accepting applications from a plurality of applicants within the target group, and c. collecting data from the applicants relating to the product or service.

The invention further provides a system for conducting market research in relation to a product or service wherein an ownership interest in an entity related to the product or service or the market research is offered to a target group in exchange for information, comprising a server for generating an interface for accepting applications from a plurality of applicants within the target group and accepting data from the applicants relating to the product or service, and a database for storing the data from the applicants relating to the product or service.

According to one aspect of the invention, the equity ownership, security or other ownership interest may be offered in exchange for direct feedback (and/or input) from the potential respondents.

According to an aspect of the invention, the data collecting or product vending entity may be a company developing, launching and/or improving new and/or existing products (including services) of any type, including without limitation artistic creations such as music, film, television, literary works and others.

According to an aspect of the invention, the respondents may be members of a target market.

According to an aspect of the invention, the method and system of the invention may include a method or system of designing and launching (or creating awareness of) a new product.

According to an aspect of the invention, the method and system of the invention may include a. method or system of improving an existing product.

According to an aspect of the invention, the entity may provide an ownership interest in the entity to the members of the target market in exchange for their participation in designing, launching, or improving new or existing products.

According to an aspect of the invention, the respondents may provide feedback concerning design specifications for the products.

According to an aspect of the invention, the respondents may provide feedback concerning pricing for the products.

According to an aspect of the invention, the respondents may provide feedback concerning marketing approaches for the products.

According to an aspect of the invention, the entity may create awareness of the products among the members of the target market.

According to an aspect of the invention, the respondents may suggest new ideas to the data collecting and/or product vending entity.

According to an aspect of the invention, the data collecting entity may be a separate entity from the product vending entity, with the data collecting entity preferably being substantially interposed between the respondent and the product vending entity.

The method and system of the invention may be relatively inexpensive and not substantially time consuming to implement, and may generate in the respondent substantial enthusiasm for, or direct affiliation with, the product, the product vending entity, and/or the data collecting entity.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings.

An entity (for example, a product vending entity which provides a product or service) may intend to create and make available to the public, a new product and/or service. In the present description the invention will be described with reference to a product, however the term “product” includes a “service” and these terms may be used interchangeably.

The data collecting entity may be a separate entity from the product vending entity. In such event, the data collecting entity may be interposed between the respondent and the product vending entity.

The entity (data collecting entity or vending entity) may wish to obtain a list of design specifications for the new product. The entity may desire a list of design specifications to accurately align with features desired by consumers in a target market, or a list of design specifications to accurately align with features which are most desired by consumers in a target market. The entity may also wish to determine the cost to manufacture the product and/or the appropriate selling price of the new product. The appropriate selling price of the new product may be determined in relation to the cost to manufacture the product, or it may alternately be determined on the basis of direct feedback from the target market. In the latter case, the cost to manufacture the new product may be determined by the selling price.

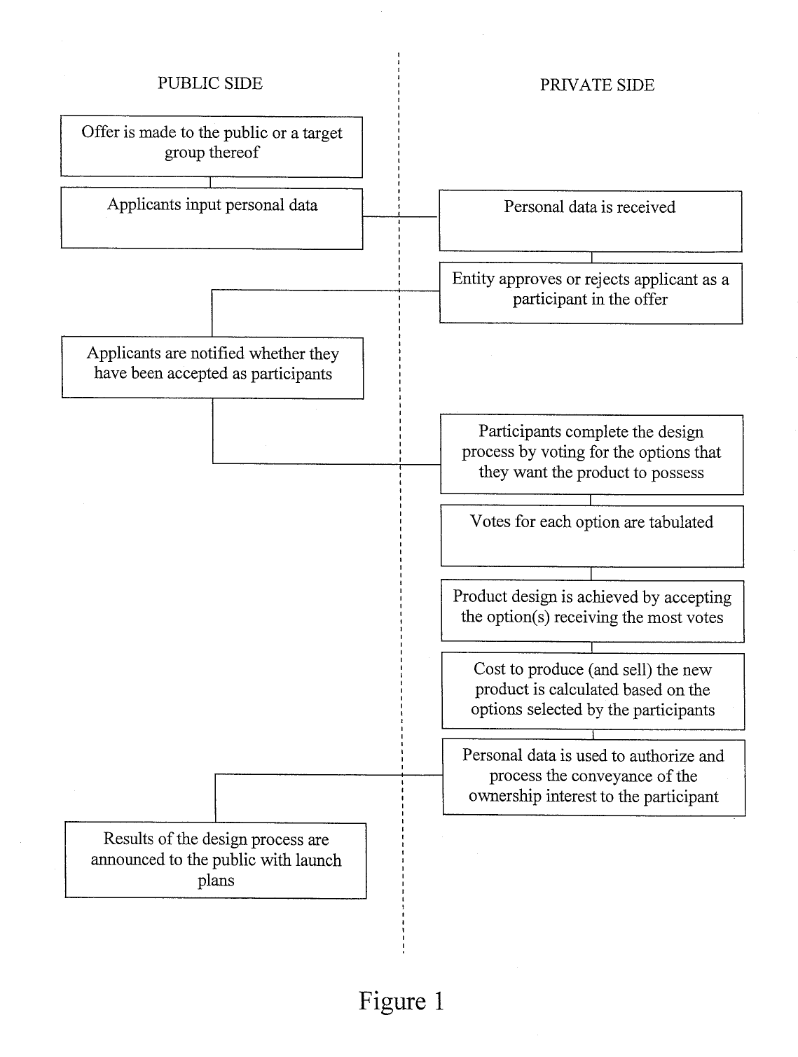

As shown in FIG. 1 by way of a preferred example only, an offer may be made publicly (for example on a website accessible over a public computer network such as the Internet) to individuals who meet the criteria of the target market for the product. The offer may be for an ownership interest in an entity (which may for example be the vending entity or a data collecting entity, or any other entity) in exchange for participation in the design process for the new product. This may include (but is not limited to) any instrument, tangible or otherwise, securing or signifying (i) a conveyance, ownership position, or right to ownership, (ii) a contractual or statutory obligation, (iii) evidence of indebtedness or a right to, or lien on, collateral or other property, and/or (iv) a transferable interest representing financial value; for example (without limitation) securities, shares, pledges, options, warrants, notes, stocks, bonds, debentures, interest certificates (whether to title, lease, and/or payments), trust certificates, temporary or interim certificates, investment contracts, negotiable documents, mutual funds, guaranteed assets, whether with a corporate issuer, a government issuer or otherwise.

All individuals and/or potential respondents wishing to accept the offer may be required to input their personal information on the entity's website through various fields on a registration page. In the event that the data collecting entity is interposed between the vending entity and the potential respondents, then the data collecting entity may be responsible for hosting the vending entity's website and presenting any desired content to the potential respondents, and for collecting and recording the personal information of the potential respondents. The offer may include a requirement that the applicant authorize his or her personal information to be forwarded to and/or used by a third party that is not associated with the process, for example a company marketing a different product.

The vending entity and/or data collecting entity may then verify that each applicant meets the criteria of the target market and/or is eligible to receive the offered ownership interest. The eligibility to receive the offered ownership interest may be determined on the basis of the potential respondents' personal information, with reference to and in accordance with any applicable regulatory requirements. In the event that the applicant does so meet the criteria and is so eligible, the applicant is approved to participate in the offer. The successful applicant then becomes a participant in the survey process, and may optionally be offered an opportunity or guarantee for a further or greater ownership interest in the vending entity and/or data collecting entity. If an applicant does not meet the criteria to receive the ownership interest or is ineligible due to regulatory issues, an alternate offer may optionally be made to the unsuccessful applicant.

Once the applicant has been approved by the vending entity (or data collecting entity) to participate in the offer, he/she may be permitted to access a web page where the design process takes place. In the event that the data collecting entity is substantially interposed between the vending entity and the respondents, then the data collecting entity may be responsible for presenting any desired content and various options to the respondents.

In the product design process, each participant/respondent may be required or given the opportunity to view and/or listen to information and options under various categories. Such categories may include, but are not limited to, taste, color, texture, scent, dimensions, performance characteristics, marketing materials, advertising, marketing strategies, label design arid any other characteristics that the company may deem necessary and/or appropriate. The participant may then vote for the option(s) under each of the categories that they want the product or service to possess.

The method and system for market research may also be used to create and/or improve various artistic creations or entertainment services or the delivery thereof, including music, film, and television. In such case, the options presented to the respondents may also include (but are not limited to) options relating to esthetic appeal, artistic styles, tempo or beats per minute, instrumentation, musical scoring, casting choices, plot devices, thematic elements, setting choices, lighting, character development, character appearance, running time, etc. The options presented to respondents (whether they relate to artistic products, entertainment or entertainment services, or to any other type of products or services) may be presented in the form of text, audio, video, and/or combinations of these formats. In some aspects the members of the target group may submit options or alternatives to the product vending entity or data collection entity, and in a later stage vote on the options or alternatives so submitted.

The product vending entity may be responsible for recording the responses or options selected by each of the respondents. In the event that a data collecting entity is interposed between the vending entity and the potential respondents, then the data collecting entity may be responsible for recording the responses or options selected by each of the respondents. The vending entity (or other entity, such as, for example, the data collecting entity) may have researched and calculated the cost to implement each option which is presented to the respondents. It is also possible to perform much of the process within a computer without manual intervention: for example, processing the votes received from the participants; determining the product design based on the features selected by the majority; calculating the cost to produce and sell the product based on the selected features; and notifying the participants of the authorization and processing of the conveyance of the ownership interest to the participant.

Under each of the presented categories, the participants may be asked to vote for the options which are most appealing to them. The votes may be collected and stored in a computer in association with each participant. Participants may be permitted to provide their own ideas to the company in addition to those which are presented to them. Since the data collecting entity may be a separate entity from the product vending entity, the data collecting entity may operate the computer or the data collecting entity might operate an additional computer which is supplemental to, or interposed between, the respondent and any computer administered by the product vending entity. Alternately, the product vending entity might administer a computer (and if desired be responsible for its own data collection) with a further yet entity (for example a data analysis entity and/or a product design entity) being responsible for tabulating the results of any market research or for incorporating or designing any desired features into any new or improved product or service.

Preferably, the number of votes for each option is then calculated. The options which receive the most votes from the respondents may be accepted by the vending entity into the design of the product. The cost to produce (and potentially the selling price of) the product may then be calculated by adding the associated costs of each option which were voted into the product design. According to the invention, the participant may then be given the previously offered ownership interest in the company (vending entity, data collection entity, or other entity preferably related to or benefiting from the sale of the product or service or the market research). Alternately, any who may have been deemed ineligible to participate (whether due to regulatory requirements or otherwise) may nonetheless be permitted to participate and may be offered alternate consideration in exchange for such participation. Such alternate consideration may include, for example (without limitation) (i) a conditional entitlement to receive the ownership interest should they later become eligible, and/or (ii) the ability to designate another individual to receive the ownership interest in their stead.

It will be appreciated that the use of the method and system of market research according to the present invention may facilitate a company's development, improvement, or launching of a new or improved consumer product or service, in an efficient amount of time and/or in an inexpensive manner, all while enabling the vending entity to obtain feedback from a target market. The use of the system and method of market research according to the invention may be effective to generate or create in respondents, a genuine emotion, motivation, enthusiasm, affiliation, and connection to the product, service, company, and/or data collecting entity. The use of the method and system of market research according to the present invention may have application in each of the following contexts: test marketing, small-scale product launches, concept testing, store auditing, product demand testing, sales forecasting, test audiences (e.g. for music, film, television), customer and/or transaction satisfaction studies, exit interviews, distribution and/or retail channel audits, price elasticity testing, consumer decision process research, relative positioning and/or comparative brand research, brand name testing, and advertising and promotion research.

Other modifications and alterations may be used in the design and manufacture of other embodiments according to the present invention without departing from the spirit and scope of the invention, which is limited only by the claims. For example, the method and system might be used in test marketing, in concept testing, in store auditing, in product demand testing, in sales forecasting, in customer and/or transaction satisfaction studies, in exit interviews, in distribution and/or retail channel audits, in price elasticity testing, in consumer decision process research, in relative positioning and/or comparative brand research, in brand name testing, and/or in advertising and promotion research, instead of in a product design context. Similarly, instead of being offered via computer over the world wide web or the interne, the system might implement telephone, facsimile, in-person, courier, mail, email, and/or other forms of communication.

1. A method of conducting a design process for a new or existing product or service, the method comprising:
making an offer available to a target group comprising a plurality of individuals, the offer comprising an ownership interest related to the product or service or alternate consideration in exchange for input into the design of the product or service;
providing an interface for enabling the plurality of individuals in the target group to apply for the offer, the interface being provided by a server computer comprising a processor;
for each applicant, providing information related to the design of the product or service, and requesting input to be incorporated into the design process based on the information;
receiving the input from each applicant via the interface;
storing the input in a database to enable the input to be incorporated into the design process; and
providing the ownership interest to at least one of the applicants.

2. The method according to claim 1, wherein the ownership interest is in an entity related to the product or service.

3. The method according to claim 2, wherein the ownership interest comprises a financial instrument granting any one or more of the following:
an interest in equity of the entity related to the product or service;
a right, upon occurrence of an event or contingency, to acquire an interest in the equity of the entity related to the product or service;
an underlying interest or security in the entity related to the product or service;
securing or signifying a conveyance, ownership position, or right to ownership;
securing or signifying a contractual or statutory obligation;
securing or signifying evidence of indebtedness or a right to, or lien on, collateral or other property; and
securing or signifying a transferable interest representing financial value, wherein the transferable interest comprises any one or more of: a security, a share, a pledge, an option, a warrant, a note, a stock, a bond, a debenture, an interest certificate, a trust certificate, a temporary or interim certificate, an investment contract, a negotiable document, a mutual fund, a guaranteed asset with a corporate issuer or a government issuer.

4. The method according to claim 1, further comprising:
enabling each applicant to suggest one or more new ideas related to the design process.

5. The method according to claim 4, further comprising:
receiving at least one new idea from at least one applicant.

6. The method according to claim 1, wherein the design process comprises any one or more of developing the product or service, launching the product or service, improving the product or service, marketing the product or service, producing the product or service, and distributing the product or service.

7. The method according to claim 1, wherein the information related to the product or service is provided using a survey process, and the input comprises one or more selections made in the survey process.

8. The method according to claim 7, wherein the survey process includes design specifications to be voted on by the applicants.

9. The method according to claim 8, further comprising collecting a plurality of votes on the design specifications and incorporating options having a significant proportion of the votes into the design of the product or service.

10. The method according to claim 1, further comprising determining if each applicant is eligible for the ownership interest according to one or more criteria.

11. The method according to claim 10, wherein if an applicant is ineligible for the ownership interest, an alternate offer is provided.

12. The method according to claim 11, wherein the alternate offer comprises any one or more of: a conditional entitlement should that applicant later become eligible, and an option to designate another individual to receive the ownership interest.

13. The method according to claim 1, wherein applying for the offer comprises obtaining personal data pertaining to the applicant.

14. The method according to claim 1, wherein the offer and information related to the product or service are provided using the interface.

15. The method according to claim 1, wherein the interface is provided over a public computer network connectable to the server.

16. The method according to claim 1, wherein the information related to the product or service relates to literary, artistic or entertainment products or services.

17. A system for conducting a design process for a new or existing product or service, the system comprising:
a server computer providing a processor and an interface operable for:
enabling a plurality of individuals in a target group to apply for an offer, the offer having been made available by the system to the target group, the target group comprising a plurality of individuals, the offer comprising an ownership interest related to the product or service or alternate consideration in exchange for input into the design of the product or service;
requesting input to be incorporated into the design process based on information provided by the system to each applicant, the information being related to the design of the product or service; and
receiving the input from each applicant; and
a database for storing the input to enable the input to be incorporated into the design process;
wherein the ownership interest is provided by the system to at least one of the applicants.

18. The system according to claim 17, wherein the ownership interest is in an entity related to the product or service.

19. The system according to claim 18, wherein the ownership interest comprises a financial instrument granting any one or more of the following:
an interest in equity of the entity related to the product or service;
a right, upon occurrence of an event or contingency, to acquire an interest in the equity of the entity related to the product or service;
an underlying interest or security in the entity related to the product or service;
securing or signifying a conveyance, ownership position, or right to ownership;
securing or signifying a contractual or statutory obligation;
securing or signifying evidence of indebtedness or a right to, or lien on, collateral or other property; and
securing or signifying a transferable interest representing financial value, wherein the transferable interest comprises any one or more of: a security, a share, a pledge, an option, a warrant, a note, a stock, a bond, a debenture, an interest certificate, a trust certificate, a temporary or interim certificate, an investment contract, a negotiable document, a mutual fund, a guaranteed asset with a corporate issuer or a government issuer.

20. The system according to claim 17, the interface being further operable for:
enabling each applicant to suggest one or more new ideas related to the design process.

21. The system according to claim 20, the interface being further operable for:
receiving at least one new idea from at least one applicant.

22. The system according to claim 17, wherein the design process comprises any one or more of developing a new product or service, launching the new product or service, improving a new product or service, and improving an existing product or service.

23. The system according to claim 17, wherein the information related to the product or service is provided using a survey process, and the input comprises one or more selections made in the survey process.

24. The system according to claim 23, wherein the survey process includes design specifications to be voted on by the applicants.

25. The system according to claim 24, wherein the interface is further operable for collecting a plurality of votes on the design specifications, to enable options having a significant proportion of the votes to be incorporated into the design of the product or service.

26. The system according to claim 17, wherein the server is further operable for determining if each applicant is eligible for the ownership interest according to one or more criteria.

27. The system according to claim 17, wherein if an applicant is ineligible for the ownership interest, an alternate offer is provided.

28. The system according to claim 27, wherein the alternate offer comprises any one or more of: a conditional entitlement should that applicant later become eligible, and an option to designate another individual to receive the ownership interest.

29. The system according to claim 17, wherein applying for the offer comprises obtaining personal data pertaining to the applicant.

30. The system according to claim 17, wherein the offer and information related to the product or service are provided using the interface.

31. The system according to claim 17, wherein the interface is provided over a public computer network connectable to the server.

32. The system according to claim 17, wherein the information related to the product or service relates to literary, artistic or entertainment products or services.
